(19) United States
(12) Patent Application Publication
(10) Pub. No.: US 2009/0198775 A1
(43) Pub. Date: Aug. 6, 2009

(54) System And Method Of Collaboration For System Development

(76) Inventors: Benny Keinan, Rehovot (IL); Yaniv Shaya, Kiryat Ono (IL); Ahi Gvirtsman, Tel-Aviv (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/262,048

(22) Filed: Oct. 30, 2008

Related U.S. Application Data
(60) Provisional application No. 61/024,919, filed on Jan. 31, 2008.

(51) Int. Cl. G06F 15/16

(52) U.S. Cl. 709/205

(57) ABSTRACT

A system and method are provided for collaboration for system development. The method can include the operation of receiving change requests for a system development project that are storable in a database. The change requests can be presented to collaboration users using a networked user interface. An additional operation is associating a discussion thread with each change request. In addition, at least one comment is able to be entered in the discussion thread for each change request by collaboration users.

### BACKGROUND

The maintenance of deployed computer networks, server systems and related software can be a complex process that uses a significant amount of personnel scheduling and organizational processes. One type of tool that might be used to schedule resources and estimate the time that will be used to maintain an information technology (IT) infrastructure and related software applications is called a Gantt chart. These more simplistic types of tracking tools have been embodied in software packages such as Microsoft Project™.

More advanced types of project development, maintenance, and collaboration tools also exist to aid a team in tracking and managing the information technology (IT) development and deployment processes. These tools include the ability for users to enter development tasks and project requests into a database so that this information can be tracked by management. Resource allocation in management software can also include task allocation for individuals and the scheduling of developers' and engineers' time. Individual developers can be assigned changing job roles as time passes. Document management can also be contained within this type of software management application.

Since a complex IT environment is constantly changing, the project development teams may meet frequently to discuss the changes to deployed systems or progress on assigned projects. As the project is worked on, change requests may be submitted for the project by customers, management, developers, and engineers. The submitted change requests can be discussed by a project's change advisory board (CAB) in order to decide which change requests will be accepted as part of the system development or project specification. When an IT infrastructure is being developed by several large teams in different locations or countries, the change advisory board can become quite large.

The change advisory board can meet using telephone conferencing or video conferencing and the change advisory board may consist of up to one hundred participants or more. In this situation, any discussed change request is likely to apply to just a certain subset of the participants. For example, a limited number of individuals (e.g., two to twenty people) may be involved in the actual decision making for the change request. As a result, the time of the remaining members of the change advisory board (who are not involved in the decision surrounding a specific change request item) is used in an inefficient or even wasteful manner.

### BRIEF DESCRIPTION OF THE DRAWINGS

FIG. 1 is a block diagram of a system for collaboration during system development via user interfaces displayed to collaboration users in accordance with an embodiment;

FIG. 2 illustrates an embodiment of a summary listing pane for change requests and an associated list of action items;

FIG. 3a illustrates an embodiment of a comment thread for a selected change request and voting summary of users for the selected change request;

FIG. 3b illustrates an embodiment of a collaboration tab's resolution view where collaboration users can approve or retract a change request;

FIG. 4 illustrates an embodiment of a user interface window containing a detailed listing of action items associated with a change request;

FIG. 5 illustrates an embodiment of a change action item status dialog box;

FIG. 6 is a flow chart illustrating an embodiment of a method of collaboration for system development.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

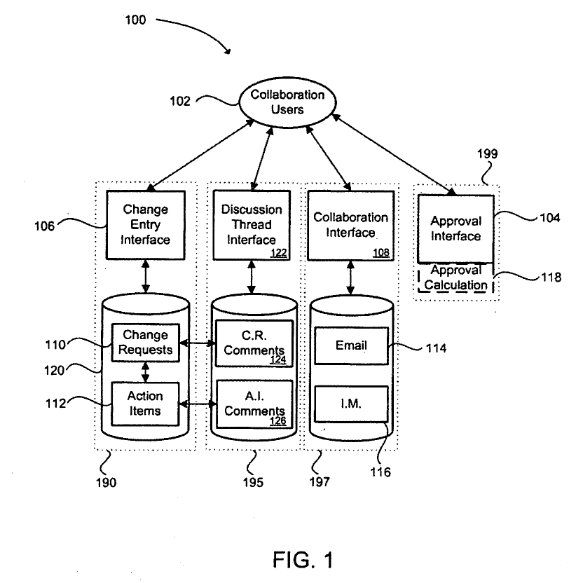

A system 100 and method are provided for collaboration during system development via user interfaces displayed to collaboration users, as illustrated in FIG. 1. The collaboration users 102 may be IT system specialists, software developers, engineers, project managers, designers, artists, customers and other individuals who are working together on an information technology project. In some situations, the collaboration users may only include change advisory committee members or the collaboration users may include every person who is associated with a system development project.

The system development may include: deployed IT infrastructure maintenance, software project development, server deployment, network installation or other types of IT related projects. In the situation where the system development is the ongoing management and maintenance of a complex deployed IT infrastructure, many types of functions may be performed such as software patching, replacing hardware, upgrading servers, and a myriad of other maintenance activities. There may be hundreds of changes per day that need to occur to manage a complex IT eco-system and it is valuable to have tools for managing an intricate and quickly changing environment. In addition, a system and method for managing changes is not only valuable from a management perspective but can also be important from the legal, compliance, and corporate accountability perspectives.

A change entry interface 106 can be configured to enable the submission of change requests by the collaboration users for a system development project, as in FIG. 1. The change entry user interface can be a graphical user interface that is web enabled. Each change request may have an assigned change request owner who is responsible for monitoring the status and verifying the completion of the change request. The change requests 110 can be stored in a database 120 that has been configured to store change request information submitted by collaboration users. The change requests can be stored in a database that is a relational database, an object oriented database, a flat file or some other database.

A discussion thread interface 122 is configured to associate a discussion thread with each change request. The user interface can enable at least one comment 124 to be entered in a discussion thread or comment thread for each change request by collaboration users. Typically, a large number of comments may also be entered into the interface. Responses to any of the existing comments or previous responses can also be made using the discussion thread interface.

The comments and responses in a discussion thread or comment thread can be organized in a sequential listing fashion in a horizontal or vertical scrolling direction. Alternatively, the comment thread may be arranged in a tree-like organization, a grid view, a menu accessible structure, or another useful comment organization. The collaboration users can view the comments and responses to see what discussion is taking place about a change item.

An action item entry interface 112 can enable a collaboration user to enter and associate at least one action item with a change request 110. Action items can be used as a control tool for collaboration users or managers to ask another user to perform a certain activity. Once an action item is created it can be easily followed-up on. An action item discussion thread 122 can be provided for each action item where comments and responses to comments 126 can be entered by collaboration users.

Associating action items with change items provides a view of action items in the context of the overall change. In addition, this connection between the action item and the change item allows the action item assignee quick access to relevant information which can aid in completing the action item.

A collaboration interface 108 can present the change requests to the assigned collaboration users on a display screen. The collaboration interface can also provide an electronic messaging interface for communication between collaboration users. The collaboration interface allows collaboration users to enable a messaging system that is integrated into the system to allow the collaboration users to directly contact each other regarding specific change items or action items. Then the collaboration user's communications can be logged and tied specifically to the change request or action item being discussed. These direct communications may be similar to email functionality 114 because the collaboration users can have an inbox within the collaboration interface. Alternatively, the communications can be more like an instant message 116, where direct messages will be immediately relayed to the collaboration users who are logged into the system. In another embodiment, the instant messages or emails can be routed through a collaboration user's preferred messaging system and then be stored in a log file associated with a change item or action item.

A group of collaboration users can be assigned to a change request for comments. The assigned group may be as small as two or three collaboration users who are given rights to make comments or the group may include every collaboration user who is able to login to the collaboration system. The collaboration users assigned to a change request may be contacted using electronic notification to request comments from the collaboration users for the change request. In other words, the collaboration users are directly asked using email or instant messaging to provide comments about a change request or action item.

An optional approval interface 104 may allow the collaboration users to vote and provide comments on presented change requests. In one embodiment, approved users can analyze whether a sufficient number of votes and/or positive comments have been made. When the approved user determines that enough positive votes have been received for a specific change item, then the approved user can add the change requests into the current system development project.

In another embodiment, the approval interface can include an optional approval calculation module 118, which can be configured to determine whether the change requests are entered into the system development project depending on whether the positive votes by collaboration users exceed a pre-defined threshold. For example, a pre-defined threshold may be set to determine whether 70-80% of votes from assigned collaboration users are in favor of including a specific change request into the current system project. The approval calculation module can then recognize when the threshold has been passed and automatically add the change request to the system development project. Similarly, the approval calculation module can be configured to send the change requests to a change advisory board when the total votes for moving the change requests to the change advisory board by collaboration users exceeds a predefined threshold.

The present system and method reduces the number of CAB meeting that are needed to 5 manage system change. Collaboration users can share their point of view about change requests and action items at a time that is convenient for the individual user. Valuable time is also saved because a collaboration user can address just the items that are relevant. In addition, any of the collaboration users may be able to share their knowledge and opinion on a particular task. The collaboration system also allows manager to be aware of what is happening in their field of responsibility without calling extensive team meetings.

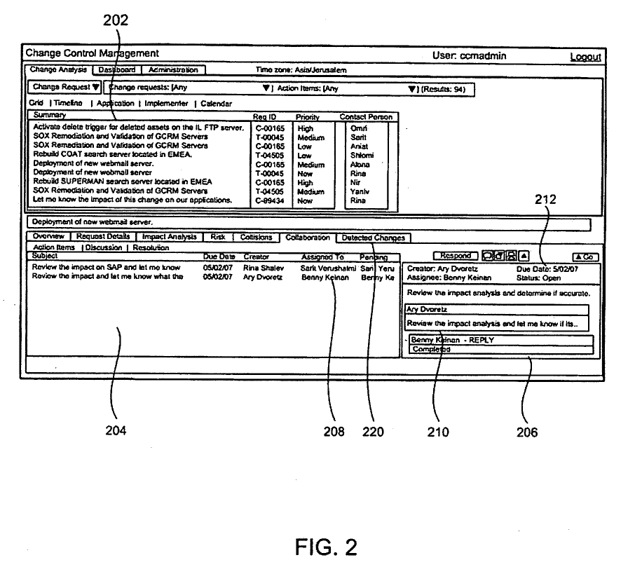

FIG. 2 illustrates a summary listing pane for change requests 202 and an associated list of action items 204 that have been created for and associated with a selected change request. Information that can be displayed for the change requests can include: a change request name, a risk factor, an identifier, a priority, a current status and a contact person. A comment and reply thread 206 for the selected action item is also illustrated. The action item comment thread can include which person has been assigned to the action item and the expected completion date 212. The system developer, who is assigned to the action item 208, can also be shown in the action item summary list 204.

The action item discussion thread and comments 210 that are posted about the action item can be displayed in a sequential listing format, a tree format or another display organization. As an example, the tree listing for comments may have a rating system that allows other collaboration users to rate comments and replies on a scale of 1 to 10, and any comments rated below a 5 may be displayed in a minimized format in the tree listing. Accordingly, there are many other formats and organizations which may be used for displaying comments and replies in a thread.

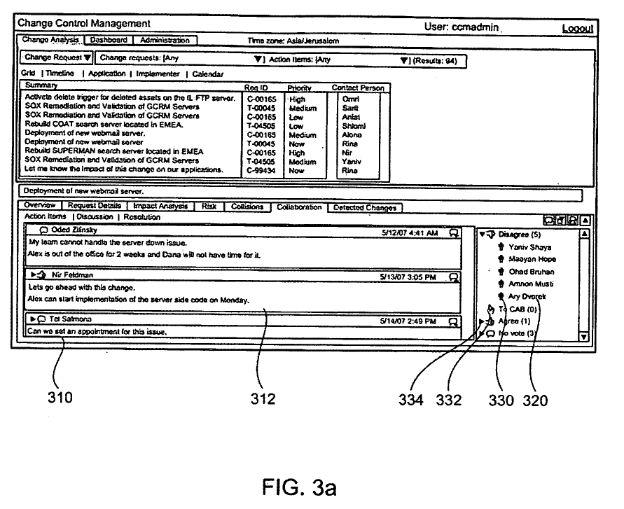

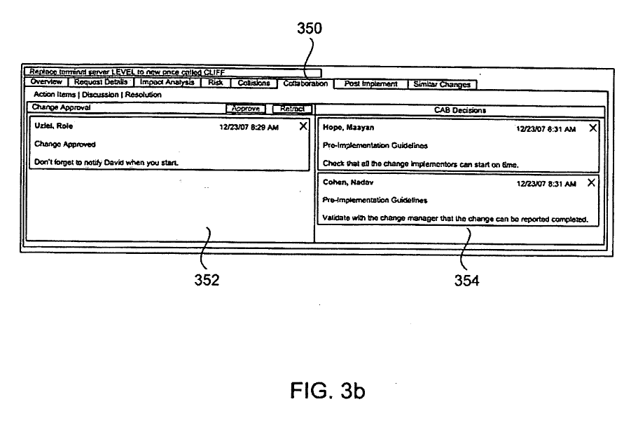

FIG. 3 illustrates the discussion thread interface 310 for a change request selected from a summary listing of change requests. A voting summary 320 is also displayed for users of the selected change request. This illustrated user interface screen allows collaboration users to enter comments 312 and replies into the discussion thread about a change request selected and viewed by the collaboration user. In one configuration, only an assigned user can make comments about the change request but in another configuration any collaboration user can create comments for the change request. These comments can be viewed in a list format that shows the oldest comments first or in an order that shows the most recent comments first. Alternatively, the comments for the change requests can be illustrated as a conversation thread for a change request that is displayed as part of a conversation tree for the change request. Email style and/or instant messaging type of communications can be provided for the collaboration users within the collaboration software. The email messages or instant messages may be associated with a change request and logged to provide a history for the change request.

Icons 330 for each collaboration user can be associated with a vote for a change request or represent the type of vote 332, as illustrated in FIG. 3. In other words, the icons can represent a voting action that a collaboration user has taken with respect to the change request. For example, the icons can represent an affirmative vote, a negative vote, a send to change advisory board vote (CAB), or an abstaining vote. The collaboration users can send items to the change advisory board when they believe the item is important and should be considered by a larger group or if the smaller group of assigned collaboration users is not able to make a clear cut decision on the change request.

FIG. 3a further illustrates that a group of collaboration users 320 can be assigned to a change request for electronic feedback and/or voting. The collaboration users assigned to a specific change request may be automatically contacted by electronic notification to request a vote from the collaboration users for the change request. The contact can be made when the users are logged into the change management system, or emails and instant messages may be sent to external email and instant messaging addresses. If the collaboration user does not desire direct electronic contact regarding the change requests, the system can be set to display a list of requested feedback items or voting items when the collaboration user logs into the change control application.

As mentioned, change requests that have been accepted as part of the system development project via the voting project can be assigned a project manager to manage the change request. A system developer can also be assigned to action items that need to be performed to complete the change request. Other types of change requests may include management follow-up, and a management user can be assigned to the change request too.

A history of the approvals and retractions made for a change request can be tracked and displayed to collaboration users. In the collaboration tab's resolution view 350, collaboration users can approve or retract a change request, as illustrated in FIG. 3b. The left side of the pane 352 is used to show the approval and retraction operations and the right side 354 is used to display guidelines of the CAB for the implementation phase and a summary of the CAB discussion regarding this change request. The ability to approve or retract a change request depends on the status of the request and whether the user has been granted “approver” status in the change control management software. If these criteria are met, the approve button may be enabled. Conversely, if the request approval is not authorized in the change control management application, an error message may be displayed to the user. The approval and/or retraction of a change request within the change control management software results in an updated status for the change request.

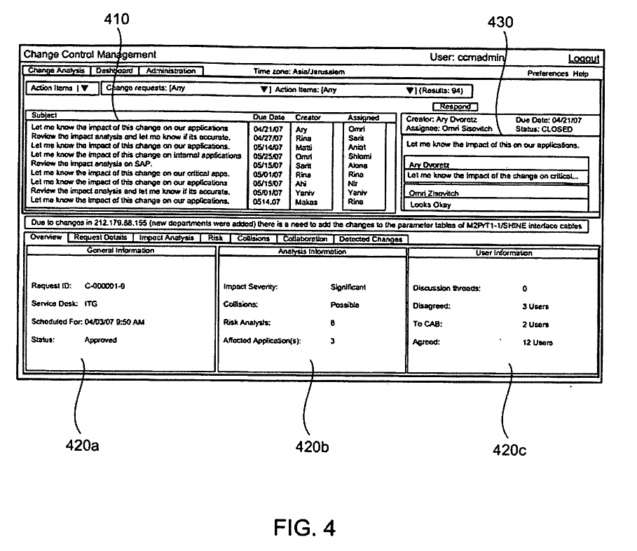

FIG. 4 illustrates a user interface window with a pane containing a detailed listing of action items 410 and the details 420a-c of the associated change request for the selected action item. Each change request can have one or more action items listed in the action item summary list and each action item may include one or more comments 430 and replies in the action item comment thread listing.

Each of the windows illustrated in FIGS. 2-4 have a collaboration tab that will display one of the following three views that enable users to add information to a change control management application regarding a specific change request. The view that is displayed in the window depends on the window context or mode.

When the window is in the change request mode, as in FIG. 2, this collaboration view enables the collaboration user to view the action items 204 associated with a change request. A user can work with the action items using the same functionality as in the action items pane when the window is in the action items mode. When the window is in the action items mode, this view enables the collaboration user to view all the action items associated with the same change request as the selected action item.

The discussion area 310 of the collaboration tab can enable users to post comments in a comment thread about a change request and to express an opinion about a change request by casting a vote 320, as illustrated in FIG. 3a. The collaboration tab's discussion view displays the discussion threads and comments as well as a summary of the votes (Agree, Disagree, To CAB) pertaining to the selected change request. This view enables users to conduct detailed online discussions about change requests prior to the change advisory board (CAB) actually meeting to discuss the change request. As a result, the CAB discussion may begin at a more advanced stage or may not be necessary at all when the collective user comments and responses are decisive regarding whether or not the change request should be approved.

The discussion view may include the following two sections. The first section may be a request discussion pane that can allow a user to scroll through all the discussion threads pertaining to the change request. Each thread can include a heading with the name of the user who initiated the discussion, an icon representing the vote posted by the discussion initiator, the date and time of the initial comment, the subject and text of the initial comment, and the comments posted by other users to the thread. The comments included in the discussion threads can be expanded or collapsed by clicking a button in the top right-hand corner of the discussion pane.

The second section of the discussion view may be a voting summary tree, which displays a summary of the most recent votes posted by discussion initiators for the change request. Each available voting option is displayed (Disagree, Agree, To CAB, and No Vote) along with the number of users who voted for that option, which may be displayed in parentheses. Generally, only the user's most recent vote is taken into account in the voting, but a history of changed votes may also be tracked as desired. A collaboration user can toggle back and forth between the voting summary tree and the request discussion pane by clicking on user interface controls near the discussion view display area.

Under each voting option, a list of users (i.e., discussion initiators) who voted for that option is displayed. Collaboration users can expand or collapse the list of users who voted under a voting option by clicking an icon 334 (e.g., an arrow) next to the voting option. When a user selects a user in the voting summary tree, all the discussion threads initiated by that user can be displayed and then accessed through the request comments pane. All of the discussion threads initiated by the users can be viewed using the voting summary tree. The threads initiated by users can be sorted by time, sorted by other criteria, or remain unsorted depending on whether that option is selected. The collaboration users can initiate more than one discussion thread for each change request. All the discussion threads are displayed along with the user's most recent vote.

Collaboration users can add a discussion thread to any change request. As part of the discussion thread, the users can express an opinion about the change by selecting one of the following voting options: Disagree, To CAB, or Agree. More than one discussion thread can be added for each change request. All the discussion threads along with the user's most recent vote are displayed in the collaboration tab. Each discussion thread may start with a subject and a message.

As discussed previously, comments can also be posted to a discussion thread. This allows collaboration users to post a comment to an existing discussion thread or to another comment within a discussion thread. Focused commenting like this enables user to discuss the change requests and action items more clearly. Copies of discussion threads can also be sent to other users by e-mail along with comments by the sender.

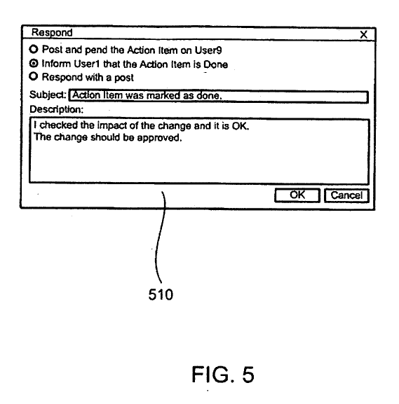

FIG. 5 illustrates a change action item status dialog box 510. This dialog box enables a collaboration user to enter information related to the action item. For example, the collaboration user may indicate that an action item is completed and the action item can be removed off the pending list. Removing the action item off the pending list may trigger an email or otherwise electronically notify the creator of the action item that the action item is complete. Alternatively, the collaboration user can enter information stating some analysis has been completed or post other comments.

The user interface windows described and illustrated in this description may be a web application and web interface that is accessed via a browser and web server. Alternatively, the user interface may be retrieved from a centralized server in a client-server fashion, retrieved using a mainframe configuration, or retrieved using other known application networking configurations and protocols.

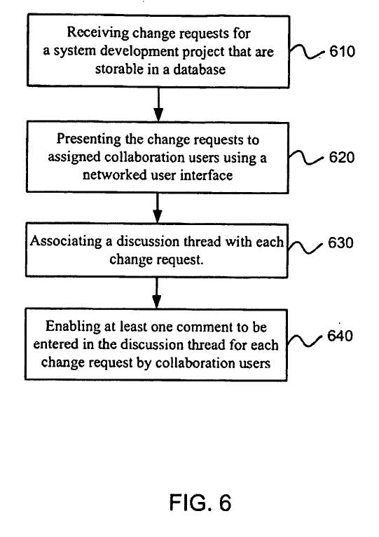

FIG. 6 is a flowchart illustrating a method of collaboration for system development. The method can include the operation of receiving change requests for a system development project that are storable in a database, as in block 610. As discussed before, the change requests are changes that collaboration users desire to have made to a system development project.

The change requests can be presented to assigned collaboration users using a networked user interface, as in block 620. The change requests may be presented in a grid listing pane of a user interface window or another type of view for the collaboration users. The change requests and other user interface modules can be viewable to collaboration users via a hardware display that is connected to a personal computer or a networked server. Collaboration users can be assigned to each change request for comments and voting purposes by the users with authority to make management decisions about change requests.

A discussion thread can be associated with each change request, as in block 630. The discussion thread enables collaboration users to enter comments. For example, comments can be made about whether the user believes the change request is valuable and should be implemented or not. The discussion thread interface enables at least one comment to be entered in the discussion thread for each change request by collaboration users, as in block 640. In practice, each discussion thread is likely to contain several comments and replies to those comments in a listing format.

In an additional embodiment, where the progress of an information technology (IT) environment or software project is being tracked, then a tool for software application mapping may be used in conjunction with the change control application for viewing detected and latent changes. An example of a mapping application is Mercury Application Mapping. Users can work with the latent changes feature in different ways. By default, the change control management application contains all the changes that are scheduled to take place in the outstanding project. Users can configure the application mapping software to periodically search for actual changes to the software environment and to send data about these changes to change control management system. This enables users to view data for both scheduled and actual changes.

The method described with respect to FIG. 6 and any of the elements related to the system and methods described here can be embodied in an article of manufacture. The article of manufacture can be a computer usable medium or computer readable medium having computer readable program code embodied therein for collaboration for system development. Examples of computer readable mediums include, but are not limited to, storage and accessing of software instructions from hard disks, tape drives, optical mediums (e.g., CD, DVD, HD-DVD, Blu-Ray), Random Access Memory (RAM), Read Only Memory (ROMs) and other similar electronic storage mediums.

The latent changes feature also enables collaboration users to determine whether changes discovered in the software project environment (discovered changes) correspond to changes that were scheduled in change control management (scheduled changes). When a change is discovered, the change control management may be configured to try to match the discovered change with scheduled changes according to certain criteria. If a discovered change matches a scheduled change according to all of the matching criteria, it is defined by the change control management system as a detected change. Detected changes are displayed with the corresponding change request in a detected changes tab (220 of FIG. 2).

If a discovered change does not match any scheduled change, or if a discovered change matches the scheduled change according to only some of the matching criteria, it is defined by change control management system as a latent change. Latent changes can be displayed as separate changes in the change requests pane, along with all the other change requests. A latent change can be indicated by a latent icon and the words “latent change” in the grid view's summary column. Information about the discovered changes received from the application mapping is displayed in the detected changes tab.

While the system and method described herein can be used for information technology projects, the described system can be used with other types of development projects which use change orders. For example, this change control software is applicable to large construction projects, airplane design, automobile design, chemical process batching systems, or any other type of large project where change orders and action items are used and collaborative communication is valuable.

In summary, a system and method are provided for collaboration on system development via user interfaces displayed to collaboration users, as in FIG. 1. The system can include a task management module 190 configured to receive change requests for a system development project and store the change requests in a database. The task management module can also include action items for each change request, as discussed previously. A communications module 195 enables collaboration users to comment on change requests or action items, and send electronic messages regarding change requests. The change requests and action items can have multiple associated discussion threads, and the threads have comments and replies associated with the threads that are accessible through the communications module. A collaboration module 199 is configured to associate collaboration users with each change request stored in the database and to enable emails and instant message logs for change requests to be presented to the assigned collaboration users.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of collaboration for system development, comprising:
receiving change requests for a system development project that are storable in a database;
presenting the change requests to collaboration users using a networked user interface;
associating a discussion thread with each change request; and
enabling at least one comment to be entered in the discussion thread for each change request by collaboration users.

2. A method as in claim 1, further comprising the step of associating at least one action item with a change request.

3. A method as in claim 2, further comprising the step of providing an action item discussion thread for each action item wherein comments can be entered by collaboration users.

4. The method of claim 2, further comprising the step of assigning a system developer to an action item.

5. The method of claim 1, further comprising the step of assigning change requests to a change request owner.

6. The method of claim 1, further comprising the step of enabling a collaboration user to enter a reply to a comment for a change request in a discussion thread viewable by collaboration users.

7. A method as in claim 1, further comprising the step of enabling the collaboration users to vote on presented change requests which determines whether the change requests are entered into the system development project.

8. The method as in claim 7, further comprising the step of entering the change requests into the system development project when total votes by collaboration users exceed a predefined threshold.

9. The method of claim 1, further comprising the step of providing email and instant messaging communications that are associated with a change request and are logged to provide a history for the change request.

10. The method of claim 1, further comprising the step of assigning a group of collaboration users to a change request for comments.

11. The method claim 1, further comprising the step of contacting the collaboration users assigned to a change request by electronic notification to request comments from the collaboration users for the change request.

12. A method of collaboration for system development, comprising:
receiving change requests for a system development project that are storable in a database;
presenting the change requests to collaboration users using a networked user interface;
associating a discussion thread with each change request;
enabling at least one comment to be entered in a discussion thread for each change request by collaboration users using the networked user interface;
associating at least one action item with a change request; and
providing a discussion thread for each action item where at least one comment can be entered by collaboration users using the networked user interface.

13. The method of claim 12, further comprising the step of assigning a system developer to an action item.

14. A system of collaboration for system development via networked user interfaces displayed to collaboration users, comprising:
a change entry interface configured to enable a change request to be submitted by the collaboration users for a system development project;
a database configured to store submitted change requests; and
a discussion thread interface configured to associate a discussion thread with each change request and to enable at least one comment to be entered in the discussion thread for each change request by collaboration users.

15. The system as in claim 14, further comprising an action item entry interface configured to associate at least one action item with a change request.

16. The system as in claim 14, further comprising an action item discussion thread interface configured to provide a discussion thread for each action item wherein comments can be entered by collaboration users.

17. The system as in claim 14, wherein the collaboration interface further comprises an electronic messaging interface for communication between collaboration users.

18. A system for collaboration on system development via networked user interfaces displayed to collaboration users, comprising:
a task management module configured to receive change requests for a system development project and store the change requests in a database;
a collaboration module configured to enable collaboration users enter at least one comment in a comment thread for change requests; and
a communications module configured to post electronic messages related to change requests.

19. The system as in claim 18, wherein each change request has at least one action item and each action item has an action item comment thread where comments are entered and viewed through the networked collaboration module.

20. An article of manufacture including a computer usable medium having computer readable program code embodied therein for collaboration for system development, comprising computer readable program code capable of performing the operations of:
receiving change requests for a system development project that are storable in a database;
presenting the change requests to collaboration users using a networked user interface;
associating a discussion thread with each change request;
enabling at least one comment to be entered in a discussion thread for each change request by collaboration users;
associating at least one action item with a change request; and
providing a discussion thread for each action item where comments can be entered by collaboration users
